(19) United States
(12) Patent Application Publication
(10) Pub. No.: US 2010/0078508 A1
(43) Pub. Date: Apr. 1, 2010

(54) Irrigation Nozzle Assembly with Fluidic insert Retention structure and method

(76) Inventors: Chris South, Columbia, MD (US); Gregory Russell, Catonsville, MD (US); Shridhar Gopalan, Westminster, MD (US); Russell Hester, Odenton, MD (US); Eric Koehler, Columbia, MD (US)

Correspondence Address: J. Andrew McKinney;& Associates, LLC, PO Box 1290, Millersville, MD, 21108, US

(21) Appl. No.: 12/563,857

(22) Filed: Sep. 21, 2009

Related U.S. Application Data
(60) Provisional application No. 61/136,744, filed on Sep. 30, 2008.

(51) Int. Cl. B05B 1/00; B23P 11/00

(52) U.S. Cl. 239/589; 29/428

(57) ABSTRACT

A sprinkler assembly includes a sprinkler housing including at least one fluidic- circuit-receiving port carrying a fluidic insert configured to receive irrigation fluid and project the irrigation fluid in a desired spray pattern. The fluidic insert is held precisely in place by a retention ring adapted for insertion into the housing's interior lumen to provide a snap or friction fit within the housing while engaging and retaining the fluidic insert against impact forces from inrushing fluid surge. The retention ring fits entirely within the sprinkler assembly's housing or package, and is economically molded as a one-piece component, and does not have any effect on external appearance of the sprinkler assembly or any adverse effect on the fluidic insert's spray pattern.

### PRIORITY CLAIMS AND REFERENCE TO RELATED APPLICATIONS

This application claims priority to related and commonly owned U.S. provisional patent application No. 61/136,744, filed Sep. 30, 2009, the entire disclosure of which is incorporated herein by reference. This application is commonly owned with related U.S. patent application Ser. Nos. 61/012,200, 61/136,745 and 12/314,242 the entire disclosures of which are also incorporated herein by reference.

### BACKGROUND OF THE INVENTION

1. Field of the Invention

The present invention relates to irrigation nozzles, sprinkler heads and methods for assembling irrigation nozzles and sprinkler heads.

2. Discussion of the Prior Art:

Sprinkler systems used for irrigating lawns and parks must be serviced periodically, to prevent damage from expansion of freezing water in the pipes and sprinkler heads. Annually, the systems are cleared of water, often with compressed air, to drive all water out of the pipes and sprinkler components. The following spring, water is re-introduced into the system and that water must first displace the air in the pipes.

Recent advances in fluidics technology have been evaluated for use in irrigation systems, partly because fluidic oscillators can be adapted to provide a very uniform pattern of fluid dispersion over an area selected for irrigation. The resistance of these new fluidic circuits to the hydraulic forces imparted by the flow of water is significantly different, when compared to an open spray nozzle, however, and so the introduction of water into a system having trapped air in the lines presents a new challenge.

Specifically, the applicants have discovered a problem with fluidic equipped sprinkler or nozzle assemblies. The issue was that under some conditions, mainly after winterization of a residential or commercial irrigation system, there is an air void in the plumbing leading up to the fluidic equipped nozzle. When the water is turned back on to the system, a slug or wavefront of water travels at a high rate of speed down the plumbing, displacing the air, and this inrushing water has significant mass and velocity, thereby accumulating momentum. The fluidic equipped nozzle assembly allows their voiding air to flow almost un-impeded, and so the flow rate and velocity of the air and the following water are very high while the air is voiding through the nozzle assembly.

That flow rate is very different from the flow rate of the nozzle assembly when water passes, which means that the inrushing water slug, when it meets the fluidic circuit, encounters a greater impedance to flow and a significantly smaller outflow velocity. A hammer-like instantaneous impact is created by the density difference between the displaced air and the slug or wave-front of inrushing water. This impact generates excessive loads that can damage a fluidic nozzle insert or force it out of the nozzle assembly's housing. The impact force produced by the hammer-like “surge” of that water slug turns out to be quite high, close to 30 lb-f in the highest flow nozzle.

There is a need, therefore, for a convenient, reliable and inexpensive assembly structure and method for protecting a fluidic equipped irrigation nozzle from the water-hammer like effect of this first inrush of water which follows voiding air.

### OBJECTS AND SUMMARY OF THE INVENTION

Accordingly, it is an object of the present invention to overcome the above mentioned difficulties by providing a convenient, reliable and inexpensive assembly structure and method for protecting a fluidic equipped irrigation nozzle from the water-hammer like effect of a first inrush of water.

In accordance with the present invention, a sprinkler assembly includes a sprinkler housing including an interior lumen and an exterior sidewall, with at least one fluidic-circuit-receiving port carrying a fluidic insert configured that receives irrigation fluid passing into the housing lumen and, in cooperation with the port, passes irrigation fluid and projects the irrigation fluid in a desired spray pattern. The fluidic insert is held precisely in place by a retention ring adapted for insertion into the housing's interior lumen to provide a snap or friction fit with the housing. The retention ring fits into the pre-existing sprinkler housing or package, allows the use of plastic material and is made as a single component for economic purposes, and does not have any effect on external appearance or fluidic performance as other more traditional fasteners would. The retention ring can be customized to fit into other commercial sprinklers or Fluidic Nozzle housings.

The sprinkler assembly includes housing defining a cylindrical interior lumen or passage for irrigation fluid (e.g., water) and a latching retention ring is inserted into that lumen (pushed into the ID of the housing from underneath). Upon complete insertion, tab features mate to a “tail” on each fluidic insert that has been installed in the sprinkler assembly. The latch “tail” on the fluidic insert allows fluidic inserts to be assembled normally into the housing without any special tooling features or assembly processes (no snap action to overcome during assembly). The insert “tail” also has a web and gusset for additional strength. In order to accommodate the webbing on the insert “tail” there is a slot cut in each latch point on the retention ring. The latch point on the retention ring is widened to ensure that the proper level of shear area is retained for the stresses and strains the part is subjected to under the hydraulic surge's mechanical load (i.e., during surge).

The retention ring is retained in the housing by a snap undercut (or press fit for female threaded application). This is a critical aspect since applicants have found that if the ring is allowed to move, then insert retention is compromised. Further to that applicants are relying on the filter to serve as a backup support to stop the retention ring from flexing or moving under the forces of the hydraulic surge.

The retention ring is preferably molded out of a conventional plastic resin as used in the rest of the sprinkler assembly. Similar material selection guarantees that there are no unexpected chemical or environmental reactions with other subcomponents. If needed, for added strength, the part can be molded from a resin with glass reinforcement.

Applicants have determined that the assembly of the present invention is a uniquely advantageous solution to the problem because it will fit into the pre-existing package, allows the use of plastic material and a single component for economic purposes, and does not have any effect on external appearance or fluidic performance as other more reinforcing fasteners would. Furthermore the retention ring concept can be customized to fit into other sprinkler head-Fluidic Nozzle housings.

The above and still further objects, features and advantages of the present invention will become apparent upon consideration of the following detailed description of a specific embodiment thereof, particularly when taken in conjunction with the accompanying drawings, wherein like reference numerals in the various figures are utilized to designate like components.

### BRIEF DESCRIPTION OF THE DRAWINGS

FIG. 1 is an exploded perspective view of a fluidic pop-up irrigation nozzle assembly or sprinkler head adapted to receive from one to four fluidics (chips or fluidic inserts) and from one to three blanks in a housing with four radially arrayed slots, a flow adjustment screw, and a retention ring that bears against a filter with shutoff surface, in accordance with the present invention.

FIG. 2 is a perspective view illustrating a retention ring configured for insertion into the nozzle assembly of FIG. 1, to secure up to four fluidic inserts in their slots, in accordance with the present invention.

FIG. 3A is a side cross section of the nozzle assembly of FIG. 1, including the retaining ring of FIG. 2 in-situ and securing up to four fluidic inserts in their slots, in accordance with the present invention.

FIG. 3B is a perspective view illustrating the structural details of the Fluidic Insert's proximal tail feature with gusset reinforcement, in accordance with the present invention.

FIG. 4 illustrates a bottom or interior view of an alternate embodiment nozzle assembly having an internal spring steel ring instead of the retaining ring of FIG. 2; the spring steel ring is shown in-situ and securing up to four fluidic inserts in their slots, in accordance with the present invention.

FIG. 5 illustrates a side partial cross section of the nozzle assembly of FIG. 4, including the steel retaining ring of FIG. 4 in-situ and securing up to four fluidic inserts in their slots, in accordance with the present invention.

### DESCRIPTION OF THE PREFERRED EMBODIMENT

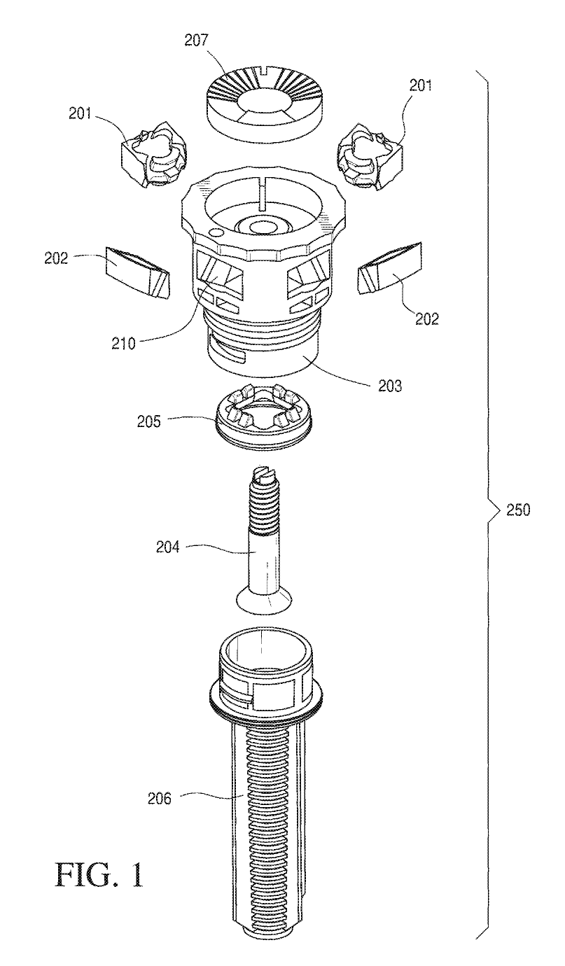

Turning now to FIGS. 1-5, in accordance with the present invention, an irrigation nozzle assembly 250 is illustrated in FIG. 1, which shows an exploded perspective view. Fluidic pop-up irrigation nozzle assembly 250 is adapted to receive from one to four fluidics 201 (i.e., chips or fluidic inserts) and from one to three blanks 202 in a housing 203 with four radially arrayed slots, a flow adjustment screw 204, and a ring-shaped retainer 205 which is configured to engage and retain the fluidic inserts.

In the illustrated embodiment, a long throw distance pop-up sprinkler head or irrigation nozzle assembly 250 achieves long throw distance using “fixed” components with no oscillating or rotating parts. While the illustrated embodiment is a “pop-up” sprinkler head adapted to function is an industry-standard form factor, other configurations are readily adapted from these examples. For example, the nozzle assembly 250 is readily altered to be “fixed”, and so need not include the “pop-up” features. The nozzle assembly described herein is configured with a housing that will work in standard sprinkler systems, in place of standard fixed or pop-up sprinkler heads.

Referring again to FIGS. 1, 2 and 3, fluidic irrigation nozzle assembly 250 preferably includes a cylindrical housing 203 having an exterior sidewall with one or more slots in which spray generating fluidic inserts 201 or sealing plugs 202 are inserted. Depending on the spray configuration desired, the appropriate number of inserts 201 are assembled, with the remaining slots filled with plugs 202. The inserts 201 and plugs 202 seal against the housing so that irrigation fluid (e.g., water) is emitted or exits only through fluidic insert throat openings. The top of housing 203 preferably has flange upper surface markings to indicate the nominal throw radius and the spray arc for the appropriate spray configuration. Spray radius adjustment screw 204 is threaded through the housing's axial bore and accessed by the installer or user from above with a simple flat-bladed screwdriver. The radius adjustment screw 204 is used to change the amount of irrigation fluid flow that enters the fluidic insert(s) and therefore affects the spray or throw radius of the emitted spray. The filter, which provides a sieve or screen and prevents debris larger than a certain size from entering the fluidic insert(s) and clogging them, can serve to hold a PCD gasket, which acts as a restrictor and shutoff for the radius adjustment screw 204.

A basic fluidic irrigation nozzle in accordance with the present invention can have a variety of spray patterns. Fixed sprays are available as Q (meaning “quarter” for 90 deg), H (meaning “half” for 180 deg), TQ (meaning “three-quarter” for 270 deg), F (meaning “full” for 360 deg), T (meaning “third” for 120 deg), TT (meaning “two-thirds” for 240 deg) and as specialty sprays. In the elementary form, a selected fluidic insert such as a Three Jet Island or a Mushroom has been used to produce a 90 deg fan. This could be a single spray or a double spray, having a fluidic geometry on both sides of an insert.

The internal structures of the fluidic oscillators are further described in this applicant's other patents and pending applications. For example, the “Mushroom” oscillator includes an oscillation inducing chamber described in U.S. Pat. No. 6,253,782 (and an improved mushroom is described in U.S. Pat. No. 7,267,290); the “Double Spray” configuration is described in U.S. Pat. No. 7,014,131; the “Three Jet” island oscillator has power nozzles feeding an interaction region and is described in U.S. Patent Application Publication 2005/0087633; and the “Split Throat” oscillator includes internal nozzles feeding an interaction chamber and is described in U.S. Patent Application Publication 2007/0295840. The entire disclosure of each the foregoing patents and published applications are incorporated herein by reference.

Nozzle assembly 250 includes a filter 206, which may optionally contain a cylindrical collar or Pressure Compensating Device (“PCD”) holder and which also defines a hollow interior lumen with an inwardly projecting annular flange that is contoured to provide a sealing surface which can act in cooperation with the flow restricting valve plug end at the proximal end of adjustment screw 204 to adjust the flow entering the lumen within housing 203. As can be seen by reference to the cross sectional view of FIG. 6, adjustment screw 104 can be threadably advanced in the proximal direction until flow restricting valve plug end at the proximal end of adjustment screw 204 is pressed against the sealing surface or valve seat defined by the inwardly projecting annular flange carried within filter 206. In this way, flow from nozzle assembly 250 can be adjusted to compensate for variations in pressure among the nozzle assemblies used in an irrigation system.

In order to throw droplets of irrigation fluid over a long distance, velocity and droplet size are very important, as is the initial aim angle. Applicants have discovered that velocity plays a stronger role than droplet size to determine the throw. This discovery enables a low PR through the proper configuration and use of fluidic sprays. Irrigation nozzle assembly 250 effectively utilizes fluidic technology to achieve good spray performance, obtaining a PR of about 1 in/hr and good spray distribution with a SC of about 1.5 without utilizing any moving components. Alternatively, using 10% greater flow yields a PR of 1.1 inch per hour with similar SC, for various examples of the nozzle assembly. The nozzle assembly is capable of providing a relatively constant precipitation rate (or Matched Precipitation Rate “MPR”) over a range of throw radius (e.g., 5, 10 or 15 feet) or arc (e.g., 90, 120, 180 or 360 degree) conditions.

Special considerations for pressure spikes in sprinkler assemblies:

As noted above, sprinkler systems used for irrigating lawns and parks must be serviced periodically, to prevent damage from expansion of freezing water in the pipes and sprinkler heads. Annually, the systems are cleared of water, often with compressed air, to drive all water out of the pipes and sprinkler components. The following spring, water is re-introduced into the system and that water must first displace the air in the pipes.

Recent advances in fluidics technology have been evaluated for use in irrigation systems, and these new fluidic circuits provide significantly different hydraulic impedance to the flow of water, when compared to an open spray nozzle, so the introduction of water into a system having trapped air in the lines presents a new challenge. Specifically, the applicants have discovered a problem with a fluidic equipped sprinkler or nozzle assembly. The issue was that under some conditions, mainly after winterization of a residential or commercial irrigation system, there is an air void in the plumbing leading up to the fluidic equipped nozzle. When the water is turned back on to the system, a wave of water travels at a high rate of speed down the plumbing, displacing the air. This instantaneous impact created by the density difference between the remaining air void and wave of water generates excessive loads that can damage an unprotected fluidic nozzle insert or force it out of the housing. The impact force produced by the “surge” turns out to be quite high, close to 30 lbf in the highest flow nozzle. This impact force is accommodated by use of a new fluidic insert retaining structure.

Referring again to FIGS. 1-3B, sprinkler assembly 250 includes a sprinkler housing 203 including an interior lumen and an exterior sidewall, with at least one fluidic-circuit-receiving port or slot 210 carrying a fluidic insert 201 configured to receive irrigation fluid passing into the housing lumen and, in cooperation with the port or slot 210, passes irrigation fluid and projects the irrigation fluid in a desired spray pattern. Fluidic insert 201 is held precisely in place by a retention member or ring 205 (as shown in FIGS. 1,2, 3A and 3B adapted for insertion into the housing's interior lumen to provide a snap or friction fit therein and to retain the pre-installed fluidic insert(s) (e.g., 201). Retention ring 205 fits into the pre-existing sprinkler housing or package, is preferably molded of plastic material and is made as a single component for economic purposes, and does not have any effect on external appearance or fluidic performance as other more traditional fasteners would.

In the preferred embodiment, retention ring 205 is molded as a one piece, unitary or single component from Polybutylene Terephtalate (“PBT”).

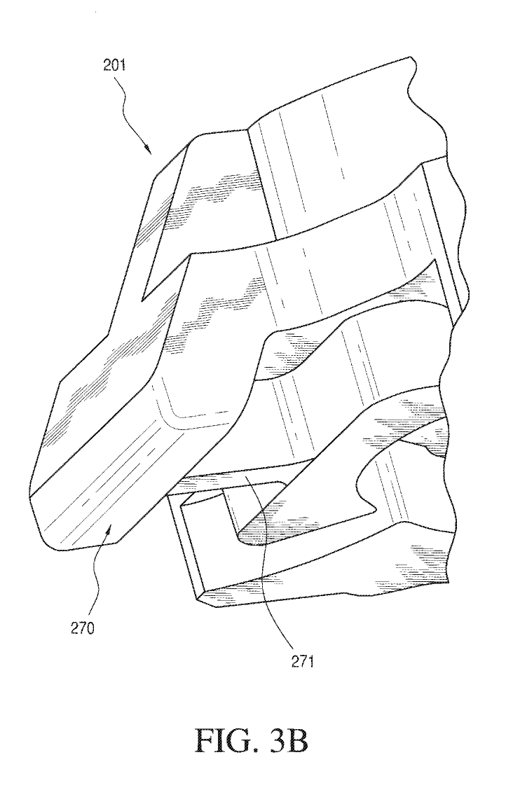

FIG. 1 is an exploded perspective view of fluidic pop-up irrigation nozzle assembly 250 which is adapted to receive from one to four fluidics 201 (chips or fluidic inserts) and from one to three blanks 202 in housing 203 with four radially arrayed and equally spaced ports or slots 210, a flow adjustment screw 204, and retention ring 205 that bears against filter 206 which has a shutoff interface surface. Housing 203 defines a substantially tubular fluid-impermeable structure that is symmetrical around a vertical axis, with a top or distal flange and a segment of exterior threads extending from the proximal or bottom end of the exterior sidewall. As can be seen in the cross sectional view of FIG. 3A, the housing sidewall includes an array of up to four upwardly angled slots 210, each defining a substantially rectangular aperture with smooth interior slot wall surfaces. As in the other embodiments described above, the interior sidewall surfaces of each port or slot 210 are preferably dimensioned for cost effective fabrication using molding methods and preferably include sidewall grooves positioned and dimensioned to form a “snap fit” with ridges or tabs in mating inserts (e.g., 201) or blanks (e.g., 202).

In an alternative embodiment, the fluidic oscillators 201 are permanently bonded within the slots, or are integral with the housing's exterior surface.

As with the embodiments described above, nozzle assembly 250 is configured with a housing 203 that will work in standard sprinkler systems, with a substantially cylindrical exterior sidewall having an outside diameter of 19.18 mm, an axial length of 11.18 mm, which terminates distally in an transverse flange having an outside diameter of 22.86 mm and carries, on its proximal end, a narrower threaded proximal tubular segment with an outside diameter of 15.01 mm. While the illustrated embodiment is “male” meaning that the proximal segment carries external threads (e.g., 5/8-28), the nozzle assembly is also readily configured as “female” meaning that the connecting threads are carried within the proximal tubular segment's interior sidewall, near the proximal end holding snap-in filter segment 206.

One, two, three or four fluidic circuit inserts or chips 201 are dimensioned to be tightly received in and held by the radially arrayed slots 210 defined within the sidewall of housing 203. The slots 210 provide a channel for fluid communication between the housing's interior lumen and the exterior of the housing. There are also between one and three plugs 202 which are also dimensioned to fit tightly within housing slots 210, and those slots fitted with a plug 202 are sealed and thus prevent any fluid passing between the housing's interior and the housing's exterior in the radial direction of the sealed slot. Housing 203 has a distal or top closed end with an annular distal flange and a dished or recessed circular end wall having a vertical and axially aligned, threaded bore that threadably receives axially aligned adjustment screw 204. The distal end or top of adjustment screw 204 preferably includes a transverse slot sized to receive a slotted screw driver. Adjustment screw 204 has an elongate shaft with threads extending from the distal end to a central portion of the shaft and the proximal end or bottom of adjustment screw 204 includes a frustoconical head which defines a flow-restricting valve plug end that can be sealed against the upper surface or interface of filter 206.

The control of fluid flow and the radius of the spray are provided by a flow conditioning proximal head of screw 204 which can be advanced to shut off fluid flow on the distal interface surface of filter 206. The shape of the head now preferred is illustrated in FIGS. 1 and 3A. The central aperture or hole size on the filter has also been seen to adversely affect the performance and an optimal hole size of 7.3 mm has been chosen. Hole sizes less than 7.3 mm may also be used for the given screw head but affect max. flow, while larger sizes result in poor performance during shutoff. Holes sizes in the range of 7.3 mm or less are believed, at present, to work well for nozzle assemblies used in applications requiring smaller throws. The proximal head of screw 204 is designed such that the head diameter is larger than the seal shutoff hole diameter on the filter basket (7.3 mm) by some minimum amount. The seal shutoff hole diameter is a minimum size for the flow requirements, and the head diameter is a maximum size for annular flow around the upper ID of the filter basket 206. Design and experiment shows this head diameter to be 7.59 mm and the seal shutoff diameter to be 7.29 mm in the preferred embodiment for the 15 ft throw configurations. The bottom of the head and seal shutoff area are also designed to deflect the irrigation fluid radially outward (away from the lumen's central axis) to help condition the flow prior to entering the chip 201. This is achieved with the preferred embodiment with sharp edge on the seal shutoff area of the filter basket.

Retention ring 205 can be customized to fit into other commercial sprinklers or Fluidic Nozzle housings. Sprinkler assembly 250 has the cylindrical interior lumen or passage and latching retention ring 250 is inserted into that lumen (pushed into the ID of the housing from underneath). Upon complete insertion, tab features 260 mate to a “tail” or latch interface 270 on fluidic insert 201 that has been installed in sprinkler assembly 250. The latch “tail” 270 on fluidic insert 201 allows fluidic inserts to be assembled normally into housing 203 without any special tooling features or assembly processes (no snap action to overcome). The insert “tail” 270 also has a web and gusset for additional strength. In order to accommodate the webbing on the insert “tail” 270 there is a slot 272 cut in each latch point on the retention ring. The latch point on the retention ring is widened to ensure that the proper level of shear area is retained for the stresses and strains the part is subjected to under the hydraulic surge's mechanical load (i.e., during surge). Tab features 260 and central square opening in retention ring 205 are strategically positioned to avoid disruption of flow conditioning prior to irrigation fluid entry into the inlet of insert 201.

Retention ring 205 is preferably retained in housing 203 by a snap undercut or groove cut into the interior wall of the housing. Retention ring has a circumferential raised boss or ridge dimensioned to snap-fit into the housing's snap undercut, thereby securing the retention ring in place and latching any installed fluidic insert 201 in place. This is a critical aspect since applicants have found that if the ring is allowed to move, then insert retention is compromised. Further to that applicants are relying on the filter 206 to serve as a backup support to stop the retention ring from flexing or moving under the forces of the hydraulic surge.

In an alternative embodiment, for a female assembly (not shown), retention ring 205 is only a press-fit within the housing's lumen. When used with a riser to which the nozzle is assembled in the field, the riser “sandwiches” the filter against the retention ring, and so press-fit is acceptable to keep retention ring 205 in place.

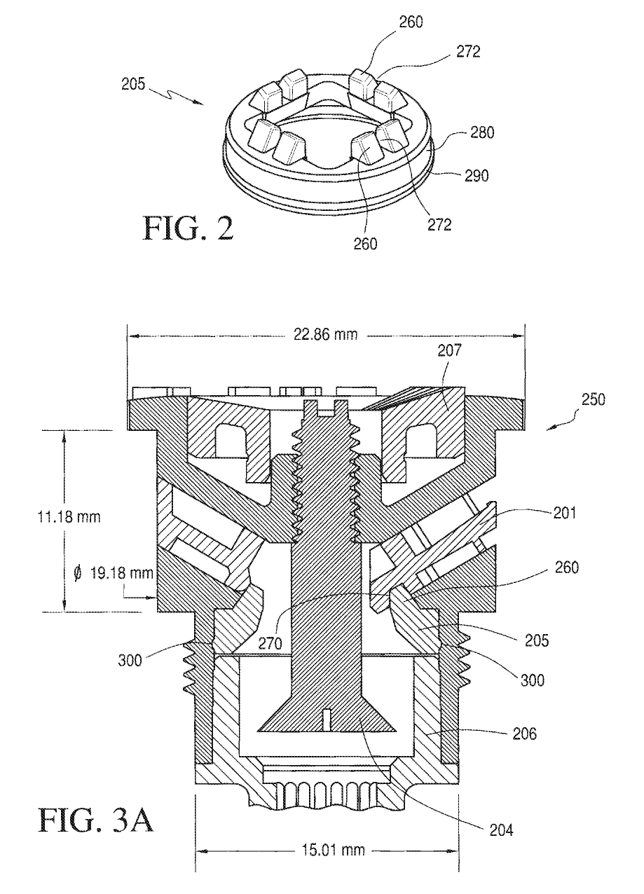

Referring now to FIGS. 2 and 3B, the main mechanism for resisting the forces of surge or water hammer include the shape of the retention ring's upwardly projecting lugs or tabs 260, which, upon insertion, project into the recesses defined in the insert's support tail 270 and thereby provide about a .030″ tall overlap or bearing surface height between insert tail 270 and the and retention ring's tabs 260, and this secure engagement prevents dislodgement of insert 201 when impacted by a surge. As best seen in FIG. 3B, insert tail 270 is reinforced with a longitudinal gusset 271 or web which provides a centrally positioned reinforcement on “tail” piece 270 of fluidic insert 201, which provides additional reinforcement against excessive tail deflection or breakage against retention ring 205. The design of FIGS. 1-3B was observed to provide much improved resistance against failure based on FEA results and prototype surge tests. In addition, a supplemental mechanism for retaining the fluidic inserts is the side retention bumps, which provide initial resistance to a surge's impulse before any clearance gap closes between insert 201 and retention ring 205. The side retention bumps also help to keep insert 201 aligned. Securing retention ring 205 to housing 203 is critical to the retention function. The ring's snap feature 290 and interference fit within housing 203 are tunable to hold ring 205 in place, and redundant support is achieved by the close fit of ring 205 with filter basket 206 (which has a secure positive snap lock to the bottom of housing 203).

As noted above, retention ring 205 is preferably molded out of a conventional plastic resin as used in the rest of the sprinkler assembly. Similar material selection guarantees that there are no unexpected chemical or environmental reactions with other subcomponents. If needed, for added strength, the ring can be molded from a resin with glass reinforcement.

Applicants have determined that nozzle assembly 205 provides a uniquely advantageous solution to the problem because it will fit into the pre-existing package, allows the use of plastic material and a single component for economic purposes, and does not have any effect on external appearance or fluidic performance as other reinforcing fasteners would. Furthermore the retention ring concept is readily adapted for use in other sprinkler head-Fluidic Nozzle housings. Due to a number of manufacturing requirements, applicants were not able to implement other designs to retain the inserts in the housing. Some ideas that were considered include:
(a) ultrasonically welding the fluidic insert into the housing—this was not desirable as welding has been found to damage the critical spray geometry and affect performance;
(b) using an external spring steel ring—Placing a generic spring steel ring around the perimeter of the housing (e.g., 203) could achieve the purpose but requires enough space on the front of the fluidic inserts to capture the ring -this external ring also poses a potential problem in damaging annular seals on the sprinkler pop-up assembly; and
(c) “Nailing”—through an access hole in the housing; a metal or plastic rod could have been driven into the insert; although this is an extremely robust method it creates a number of issues. (i) It creates a leak path for the irrigation fluid, (ii) poor repeatability in installation force and location could damage critical spray geometry, and (iii) the added cost of multiple parts was deemed not economically feasible.

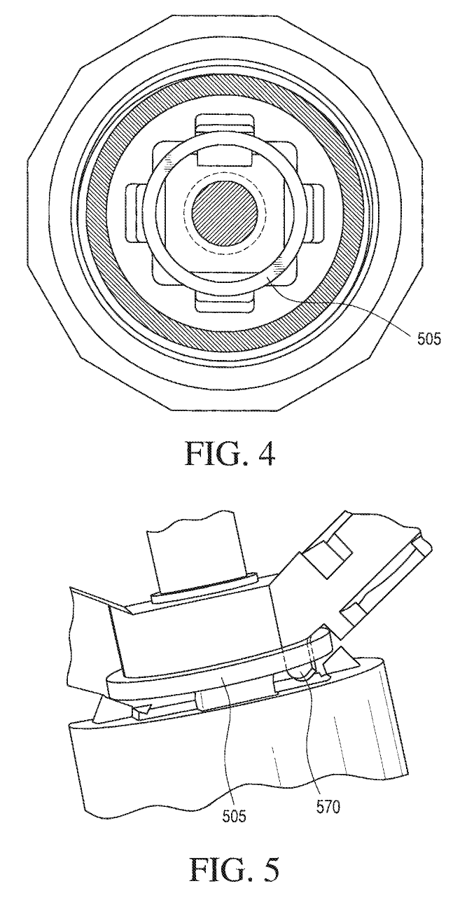

Another embodiment substitutes an internal spring steel ring 505 (see FIGS. 4 and 5) which engages and retains fluidic insert having a proximal ring engaging tail 570. It was observed that with an internal steel spring 505, the flow conditions into the nozzle feed areas would be partially obstructed by the spring's circular section, and so this alternative was deemed less desirable, but viable.

Broad Concepts for Retention Ring Component:

Due to a number of customer and manufacturing requirements applicants were not able to implement other designs to retain the inserts in the housing.

Some ideas that were considered included:

Ultrasonically welding the fluidic insert into the housing—This is not desirable as welding has been found to damage the critical spray geometry and affect performance.

External spring steel ring—Placing a generic spring steel ring around the perimeter of the housing could achieve the purpose but there was not enough exterior wall surface area or space on the front of the fluidic inserts to capture the ring. An external ring also poses a potential problem in damaging annular seals on the sprinkler pop-up assembly.

“Nailing”—Through an access hole in the housing a metal or plastic rod could have been driven into the insert. Although this is an extremely robust method it creates a number of issues: namely, the nail's bore creates a leak path for the supply water; poor repeatability in nail installation force and location could damage critical spray geometry; finally, the added cost of multiple parts was not economically feasible.

The internal spring steel ring 505 (see FIG. 4)—This was a viable alternative but because the flow conditions into the nozzle feed areas would be partially obstructed by the circular section at the corners it was not deemed a desirable design for commercially reasonable the packaging constraints.

Additional concepts were discussed but were not pursued due to major design obstacles, concerns over end user damage or manufacturing constraints.

Referring again to FIGS. 1-5, in accordance with the present invention, a sprinkler assembly includes housing defining an interior lumen or passage for irrigation fluid (e.g., water) and a latching retention ring (e.g., 205) is inserted into that lumen (pushed into the ID of the housing from underneath). Upon complete insertion, tab features 260 mate to a retaining groove, slot aperture of recessed socket 270 defined in or by a proximal latch member or “tail” on each fluidic insert that has been installed in the sprinkler assembly (FIG. 3A). The latch or “tail” 270 on the fluidic insert allows fluidic inserts to be assembled normally into the housing without any special tooling features or assembly processes. The insert “tail” 270 also has a reinforced web and gusset 271 for additional strength. In order to accommodate the webbing 271 on the insert “tail” 270 there is a slot 272 cut in each upwardly projecting tab or latch point 260 on the retention ring 205 (see, e.g., FIG. 2). Latch point 260 on the retention ring is widened to ensure that the proper level of shear area is retained for the stresses and strains the retention ring is subjected to under the hydraulic surge's mechanical load (i.e., during surge).

Retention ring 205 has a cylindrical outer peripheral wall 280 and a rounded protuberance or raised circumferential lip 290 that projects radially away from outer peripheral wall 280 to define a snap ring projection. In use, retention ring 205 is retained in housing 203 by a snap undercut or groove 300 defined in the housing's interior sidewall surface, and when retention ring 205 is inserted into housing 203, snap ring projection 280 snaps into and is retained within snap undercut 300 in the housing's interior sidewall surface. This is a critical aspect, since applicants have found that if the retaining ring 205 is allowed to move, insert retention is compromised.

Retention ring stability is also provided by the filter 206 which serves as a backup support to stop retention ring 205 from flexing or moving under the forces of the hydraulic surge.

Retention ring is preferably molded out of a conventional plastic resin which is selected for compatibility with the rest of the sprinkler assembly. Similar material selection guarantees that there are no unexpected chemical or environmental reactions with other subcomponents. If needed, for added strength, the part can be molded from a resin with glass reinforcement.

Applicant's have determined that the assembly of the present invention is a uniquely advantageous solution to the problem because it will fit into the pre-existing package, allows the use of plastic material and can be fabricated as a single one piece component for economic purposes, and does not have any effect on external appearance or fluidic performance as other more reinforcing fasteners would. Retention ring 205 is readily adapted for use in other sprinkler head-Fluidic Nozzle housings.

It will be appreciated by persons of skill in this art that the present invention makes a new fluidic insert retaining structure and method available. In accordance with the present invention, a nozzle assembly 250 includes a housing 203 including an interior lumen and an exterior sidewall, with at least one fluidic-circuit-receiving port (e.g., 210) defining a fluid passage between the lumen and the housing's exterior sidewall. A fluidic insert (e.g., 201) is configured to receive fluid passing into the housing's lumen and, in cooperation with port 210, passes the fluid distally or outwardly beyond the sidewall, projecting the fluid in a desired spray pattern. Each fluidic insert has a proximal intake that is in fluid communication with the housing's interior lumen and a distal outlet that is positioned and configured to project the desired spray pattern outwardly and away from the housing's exterior sidewall, and the fluidic insert(s) each include a proximal structural feature 270. The nozzle assembly further includes a retention member or ring (e.g., 205) adapted for insertion into the housing's interior lumen to engage the fluidic insert's proximal structural feature 270 and retain the fluidic insert in-situ, even when impacted by a surge of fluid or water hammer event.

Alternatively, the retention member is not configured as a ring, but instead is configured as an arbitrary shape which engages the interior of the housing 203 with a sidewall engaging feature such as a laterally projecting protuberance, pin or ridge which engages an aperture or groove (e.g., resembling, in cross section, groove or undercut 300) in the housing sidewall, and which extends upwardly or distally to provide a fluidic circuit engaging feature or tab configured to engage an aperture or slot near the proximal end of each fluidic to be retained; it is noted that this configuration is thought to be less likely to be effective and economical in use.

The method of the present invention includes the following process steps: providing a sprinkler housing 203 including an interior lumen and an exterior sidewall, with at least one fluidic-circuit-receiving port 210 defining a fluid passage between the lumen and the sidewall; providing a fluidic circuit insert 201 configured to receive irrigation fluid passing into the housing lumen and, in cooperation with port 210, pass irrigation fluid beyond the sidewall, projecting the irrigation fluid in a desired spray pattern; inserting fluidic circuit 201 insert into port 210 so the fluidic insert has an intake that is in fluid communication with the housing's interior lumen and an outlet that is positioned and configured to project the desired spray pattern outwardly and away from the housing's exterior sidewall; inserting a retention ring 205 adapted for insertion into the housing's interior lumen to engage and retain said fluidic insert 201 by engaging the insert's tail structure 270 with locking or supporting structures such as the ring's tabs 260.

The method preferably includes positioning retention ring 205 so that it fits entirely within the housing lumen and does not have any adverse effect on fluidic spray performance. Preferably, an assembler snap-fits retention ring 205 into place so that it fits entirely within the housing lumen and, optionally, the assembler may then snap-fit filter basket 206 onto housing 203, thereby forcing retention ring 205 into place so that it fits entirely within the housing lumen and does not have any adverse effect on fluidic spray performance.

Having described preferred embodiments of a new and improved method, it is believed that other modifications, variations and changes will be suggested to those skilled in the art in view of the teachings set forth herein. It is therefore to be understood that all such variations, modifications and changes are believed to fall within the scope of the present invention as set forth in the following claims.

What is claimed is:

1. A nozzle assembly, comprising:
a housing including an interior lumen and an exterior sidewall, with at least one fluidic-circuit-receiving port defining a fluid passage between said lumen and said sidewall;
a fluidic insert configured to receive fluid passing into said housing lumen and, in cooperation with said port, pass said fluid beyond said sidewall, projecting said fluid in a desired spray pattern;
wherein said fluidic insert has a proximal intake that is in fluid communication with said housing's interior lumen and a distal outlet that is positioned and configured to project said desired spray pattern outwardly and away from said housing's exterior sidewall, and wherein said fluidic insert includes a proximal structural feature; and
said sprinkler assembly further including a retention member configured for insertion into said housing's interior lumen to engage said fluidic insert's proximal structural feature and retain said fluidic insert in-situ.

2. The assembly of claim 1, wherein said retention member comprises a retention ring configured to fits into a pre-existing commercial sprinkler or irrigation nozzle housing.

3. The assembly of claim 1, wherein said retention member comprises a ring molded from a plastic material configured as a single component.

4. The assembly of claim 1, wherein said retention member comprises a ring configured so that insertion into said housing does not alter the external appearance or fluidic performance of said sprinkler or irrigation nozzle assembly.

5. A method for strengthening a sprinkler or irrigation nozzle assembly against water hammer or pressure surges which would otherwise damage or alter fluidic circuit performance, comprising:
(a) providing a sprinkler housing including an interior lumen and an exterior sidewall, with at least one fluidic-circuit-receiving port defining a fluid passage between said lumen and said sidewall;
(b) providing a fluidic circuit insert configured to receive irrigation fluid passing into said housing lumen and, in cooperation with said port, pass irrigation fluid beyond said sidewall, projecting said irrigation fluid in a desired spray pattern;
(c) inserting said fluidic circuit insert into said housing's port so said fluidic insert has an intake that is in fluid communication with said housing's interior lumen and an outlet that is positioned and configured to project said desired spray pattern outwardly and away from said housing's exterior sidewall;
(d) inserting a retention ring adapted for insertion into said housing's interior lumen to engage and retain said fluidic insert.

6. The method of claim 5, further comprising:
(e) positioning said retention ring so that it fits entirely within said housing lumen and does not have any adverse effect on fluidic spray performance.

7. The method of claim 5, further comprising:
(e) snap-fitting said retention ring into place so that it fits entirely within said housing lumen and does not have any adverse effect on fluidic spray performance.

8. The method of claim 5, further comprising:
(e) snap-fitting a filter basket onto said housing and forcing said retention ring into place so that it fits entirely within said housing lumen and does not have any adverse effect on fluidic spray performance.
